(19) United States
(12) Patent Application Publication
(10) Pub. No.: US 2008/0273742 A1
(43) Pub. Date: Nov. 6, 2008

(54) Watermark Embedding

(75) Inventor: Aweke Negash Lemma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,466

(22) PCT Filed: Dec. 6, 2004
(86) PCT No.: PCT/IB04/52676

§ 371 Date: Jun. 14, 2006

(30) Foreign Application Priority Data
Dec. 19, 2003 (EP) 03104843.2

(51) Int. Cl. G06K 9/00

(52) U.S. Cl. 382/100

(57) ABSTRACT

Disclosed are methods and systems for embedding watermarks in information signals to obtain a watermarked information signal. The method of embedding a watermark comprises the steps of determining a predetermined first property of a first part of the information signal, said predetermined first property being indicative of whether at least a predetermined first part of the watermark signal is detectable in the first part of the information signal; embedding the at least first part of the watermark in the first part of the information signal to obtain the watermarked information signal, if the at least first part of the watermark signal is determined not to be detectable in the first part of the information signal; otherwise generating the watermarked information signal to include the first part of the information signal.

### FIELD OF THE INVENTION

The invention relates to the embedding of watermarks in information signals.

### BACKGROUND OF THE INVENTION

In the context of digital signal distribution, e.g. the distribution of multimedia content via the Internet, it is generally desirable to be able to provide protection against unauthorized further distribution of the distributed signals. For example, this is an important issue in the context of distributing copyright protected material. An example of such a scenario is an electronic music delivery system where audio content, e.g. songs, is distributed from a server computer via the Internet to one or more client computers.

Digital watermarks may be embedded in the distributed information signals in order to label the distributed content and allowing the distributor or another authority to track the distributed content, e.g. to track the content sent to individual users.

Generally, a watermark is added to a signal by modifying one or more signal parameters such that the modifications can later be recovered, e.g. by the inverse procedure of the embedding process, thereby allowing the detection of the watermark. In general, it is desired that the embedded watermark is not perceptible, e.g. by listening to a watermarked audio signal, or by viewing a watermarked image or video signal. On the other hand, the watermark should be robust, e.g. against signal deteriorations, or signal processing steps, such as compression, modulation, demodulation, filtering, or the like.

Hence, it is a general problem within the field of watermarking to find a suitable balance between robustness and perceptibility, e.g. audibility in the case of audio material. For a given robustness of an audio watermark it is generally desirable to maintain the best possible audibility.

US patent application no. 2002/0090111 discloses a watermarking system for embedding a watermark in image data prior to MPEG2 encoding. The encoded signal is decoded and subjected to watermark detection. The detected watermark information is fed back to the watermark embedding controller for controlling the embedding depth. Even though this allows the prevention of the fading of the embedded watermark due to the encoding process, the above prior art system has the disadvantage that the resulting watermarked signal does not maintain an optimal balance between robustness and perceptibility.

### OBJECT AND SUMMARY OF THE INVENTION

It is an object of the present invention to improve the perceptibility of a watermark without decreasing the robustness. In particular, in the context of audio signals, it is an object of the present invention to improve the perceivable audio quality of a watermarked audio signal without compromising the robustness of the embedded watermark.

The above and other problems are solved by a method of embedding a watermark signal in an information signal to obtain a watermarked information signal; the method comprising
determining a predetermined first property of a first part of the information signal, said predetermined first property being indicative of whether at least a predetermined first part of the watermark signal is detectable in the first part of the information signal;
embedding the at least first part of the watermark in the first part of the information signal to obtain the watermarked information signal, if the at least first part of the watermark signal is determined not to be detectable in the first part of the information signal; otherwise generating the watermarked information signal to include the first part of the information signal.

Hence, the embedding process analyzes whether a part of the information signal inherently comprises the property that the watermark embedding would induce. If this is the case, the watermark is not embedded in that part of the signal. Consequently, a method of watermarking an information signal is provided that reduces the amount of signal modifications without significantly compromising the robustness of the embedded watermark.

It is an advantage of the present invention that unnecessary modifications to the information signal are avoided, thereby improving the perceptibility of the watermarked signal without reducing the robustness of the watermark.

For the purpose of the present description, the term information signal refers to any analog or digital signal or data comprising information content, in particular perceptual information to be distributed, such as images, moving pictures, audio, or combinations of the above. Examples of such information signals include multimedia signals, such as video signals, audio signals, images, pictures, etc. In some embodiments the information content is encoded as a digital information signal. For example, audio signals may be encoded according to an audio coding scheme, e.g. MPEG-1, MPEG-2, MPEG-3, MPEG-2 AAC, or the like.

The term digital watermark comprises any digital data item which is to be embedded in an information signal by modifying samples of the signal. Preferably, a watermarking scheme should be designed such that the watermark is imperceptible, i.e. that it does not affect the quality of the information signal significantly. In many applications, the watermark should further be robust, i.e. it should still be reliably detectable after possible signal processing operations.

In a preferred embodiment of the invention, the step of embedding the at least first part of the watermark in the first part of the information signal to obtain the watermarked information signal comprises
embedding the at least first part of the watermark in the first part of the information signal to obtain a modified part-signal;
determining a predetermined second property of the modified part-signal, said second property being indicative of whether said embedding results in a detectable modification of the first part of the information signal; and
generating the watermarked information signal to include the modified part-signal, if the embedding is determined to result in a detectable modification of the first part of the information signal and if the at least first part of the watermark signal is determined not to be detectable in the first part of the information signal; otherwise generating the watermarked information signal to include the first part of the information signal.

Hence, the embedding process analyzes whether the watermark embedding in a part of the signal results in a detectable modification and whether at least first part of the watermark is inherently detectable in the first part of the information signal, and embeds the watermark in that part of the signal, only if the embedding results in a detectable modification and at the same time the at least first part of the watermark is not inherently detectable in the first part of the information signal.

It is a further advantage that the method according to the invention analyzes a number of local modifications or micro-modifications to the information signal, in order to determine whether a watermark embedding in a certain part of the information signal provides a detectable modification and whether the watermark is inherently present in the first part of the information signal. Consequently, the necessity and effect of local modifications on the global watermark detection is analyzed and used to determine whether a given local modification should be performed.

It is another advantage of the invention that signal modifications are avoided that would result in a quality deterioration without significant contribution to the watermark detection.

The second predetermined property may be the same property as the first predetermined property and, alternatively, it may be a different property. Examples of suitable properties indicative of whether an embedding results in a detectable modification include and estimate of an embedded watermark symbol in the corresponding signal.

Further preferred embodiments are disclosed in the dependent claims.

The present invention can be implemented in different ways including the method described above and in the following and an arrangement, each yielding one or more of the benefits and advantages described in connection with the first-mentioned method, and each having one or more preferred embodiments corresponding to the preferred embodiments described in connection with the first-mentioned method and disclosed in the dependent claims.

It is noted that the features of the methods described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

Here and in the following, the term processing means comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

The invention further relates to an arrangement for embedding a watermark in an information signal; the arrangement comprising
analyzing means for determining a predetermined first property of a first part of the information signal, said predetermined first property being indicative of whether at least a predetermined first part of the watermark signal to be embedded is detectable in the first part of the information signal;
embedding means for embedding the at least first part of the watermark in the first part of the information signal to obtain a modified part-signal;
a watermarked signal generator for generating a final watermarked information signal; and
control means for controlling the watermarked signal generator to include the modified part signal in the final watermarked information signal, if the at least first part of the watermark signal is determined not to be detectable in the first part of the information signal; otherwise controlling the watermarked signal generator to include the first part of the information signal in the final watermarked information signal.

The invention further relates to a watermarked information signal generated by a method described above and in the following, the watermarked information signal comprising a plurality of part-signals, a first subset of the plurality of part-signals having embedded therein respective watermark symbols, a second subset of part-signals having no watermark symbols embedded therein.

According to another aspect, the invention relates to a method of embedding a watermark signal in an information signal to obtain a watermarked information signal; the method comprising
embedding at least a first part of the watermark in a first part of the information signal to obtain a modified part-signal;
determining a predetermined first property of the modified part-signal, said first property being indicative of whether said embedding results in a detectable modification of the first part of the information signal;
generating the watermarked information signal to include the modified part-signal, if the embedding is determined to result in a detectable modification of the first part of the information signal; otherwise generating the watermarked information signal to include the first part of the information signal.

Hence, the embedding process analyzes whether the watermark embedding in a part of the signal results in a detectable modification and embeds the watermark in that part of the signal, only if the embedding results in a detectable modification. Consequently, a method of watermarking an information signal is provided that reduces the amount of signal modifications without significantly compromising the robustness of the embedded watermark.

It is a further advantage that the method according to the invention analyzes a number of local modifications or micro-modifications to the information signal, in order to determine whether a watermark embedding in a certain part of the information signal provides a detectable modification. Consequently, the effect of local modifications on the global watermark detection is analyzed and used to determine whether a given local modification should be performed.

It is another advantage of the invention that signal modifications are avoided that would result in a quality deterioration without significant contribution to the watermark detection.

The invention further relates to an arrangement for embedding a watermark in an information signal; the arrangement comprising
embedding means for embedding at least a first part of the watermark in a first part of the information signal to obtain a modified part-signal;
analyzing means for determining a predetermined first property of the modified part-signal, said first property being indicative of whether said embedding results in a detectable modification of the first part of the information signal;
a watermarked signal generator for generating a final watermarked information signal; and
control means for controlling the watermarked signal generator to include the modified part-signal in the final watermarked information signal, if the embedding is determined to result in a detectable modification of the first part of the information signal; otherwise controlling the watermarked signal generator to include the first part of the information signal in the final watermarked information signal.

### BRIEF DESCRIPTION OF THE DRAWINGS

These and other aspects of the invention will be apparent and elucidated from the embodiments described in the following with reference to the drawing in which:

FIG. 1 shows a schematic block diagram of an embodiment of a system for embedding a watermark;

FIG. 2 shows a generalised block diagram of an embodiment of a system for embedding a watermark;

FIG. 3 shows a schematic block diagram of an embodiment of a system for embedding a watermark in an audio signal;

FIG. 4 schematically illustrates a window shaping function for use in the watermark embedder of FIG. 3; and

FIG. 5 shows a flow diagram of an embodiment of the process performed by the analysis unit of FIG. 3.

### DESCRIPTION OF PREFERRED EMBODIMENTS

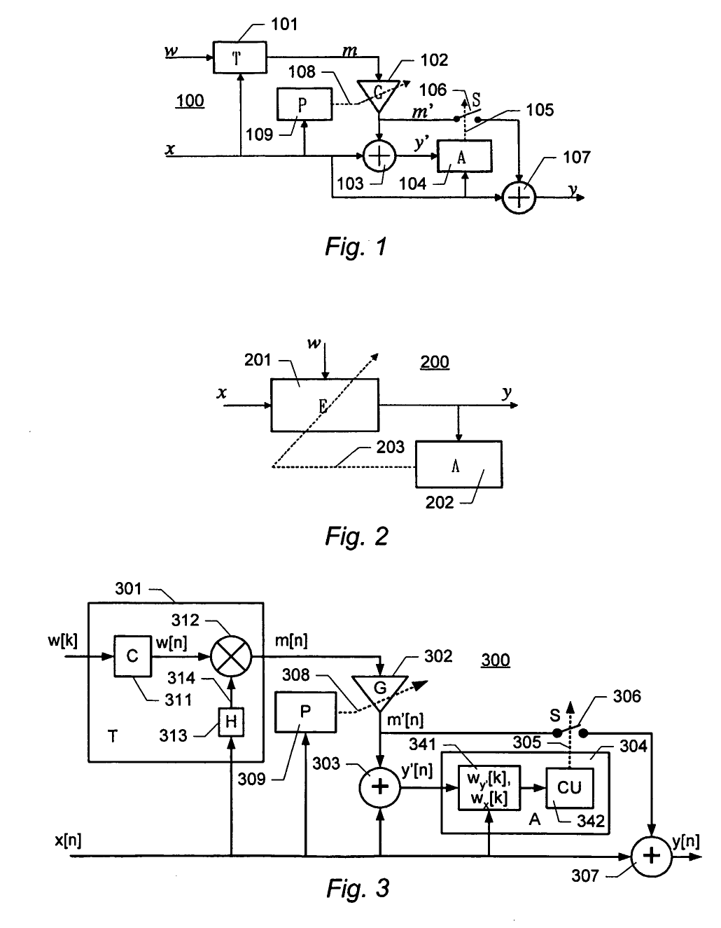

FIG. 1 shows a schematic block diagram of an embodiment of a system for embedding a watermark. The watermark embedder generally designated 100 receives an information signal x and a watermark signal w including a predetermined watermark payload to be embedded in the information signal x.

The embedder 100 comprises a watermark transformation unit 101 that receives the watermark signal w and the information signal x and generates a modifier signal m according to a predetermined watermarking scheme. The modifier signal m is generated such that it may be combined with the information signal x. For example, the processing performed by the watermark transformation unit 101 may comprise a modulation of the watermark signal, or the like. An example of a transformation unit will be described in connection with an audio watermark embedder below. The modifier signal m is scaled by a gain control unit 102 resulting in a scaled modifier signal m′. The gain control unit 102 is controlled via a control signal 108 received from an embedding model unit 109. The embedding model unit 109 receives the information signal and determines a suitable embedding strength of the watermark dependent on predetermined properties of the information signal. For example, the embedding model unit may implement a known psycho-acoustic model.

The scaled modifier signal m′ is fed to an adder circuit 107 via a switch 106. The adder circuit 107 further receives the information signal x and generates a final watermarked signal y as a combination of the information signal modified by the signal received from the switch 106.

The scaled modifier signal m′ is further fed into a second adder circuit 103 that further receives the information signal x and that combines the information signal x with the scaled modifier signal m′ resulting in the watermarked signal y′.

The watermarked signal y′ is fed into an analysis unit 104. The analysis unit 104 further receives the information signal x. The analysis unit 104 analyzes a predetermined property of the watermarked signal y′ and of the information signal x resulting in a control signal 105 that controls the switch 106. In particular, the analysis unit 104 determines whether adding the modifier signal m′ to the information signal x results in a detectable modification of the information signal. The analysis unit 104 further determines whether the information signal x inherently comprises properties that would have been induced by the watermark.

If at least one of the above criteria is fulfilled, i.e. if adding the modifier signal results in a detectable modification and/or the information signal inherently comprises properties that would have been induced by the watermark, then embedding the watermark would not improve the subsequent detectability of the watermark. Accordingly, if at least one of the above criteria is fulfilled, the analysis unit 104 generates a corresponding control signal 105 causing the switch 106 to open, thereby causing the corresponding portion of the information signal to be passed through the adder 107 without being modified. In the opposite case, i.e. when none of the above criteria is fulfilled, the analysis unit causes the switch 106 to close, thereby causing the corresponding portion of the information signal to be modified in the adder 107.

It is understood that the switch 106 may be configured to cause a continuous, smooth transition from an open state to a close state and vice versa, thereby reducing possible artifacts in the watermarked signal y caused by abrupt transitions. In other embodiments, the switch 106 may be replaced by an automatic gain control unit continuously controlling the modification strength based on the degree to which the above mentioned two criteria are fulfilled.

Hence, in the above, a feedforward embodiment of a watermark embedder was disclosed that provides a minimal modification of the information signal.

FIG. 2 shows a generalized block diagram of an embodiment of a system for embedding a watermark. The embedder generally designated 200 comprises an embedding unit 201 and an analysis unit 202. The embedding unit receives the information signal x and the watermark signal w, and the embedding unit embeds the watermark w into the information signal. The resulting watermarked signal y is fed into the analysis unit 202 that analyzes a predetermined property of the watermarked signal to determine whether adding the watermark results in a detectable modification, and whether the intended modification is inherently contained in the signal.

A specific example of analysis unit will be described in greater detail below, where the presence or absence of a watermark symbol in corresponding frames of the watermarked signal and in the information signal are detected by an analysis of the waveforms of the corresponding signals. Further examples of specific properties that may be analysed by the analysis unit in order to test the above criteria include short-time envelope of the waveforms, the relative amplitudes and/or phases of the FFT coefficients, the relative amplitudes of the MDCT, DCT and Wavelet transform coefficients, the auto-correlation functions of the waveforms, etc. The analysis unit generates a control signal 203 to the embedding unit 201 controlling the embedding based on the above criteria. In particular, if either the modification is undetectable or the original signal inherently contains the desired property, the analysis unit 202 controls the embedding unit 201 to directly pass the information signal to the output y without modification. Consequently, a reduction of the amount of information added to the host signal x is achieved, without compromising the detection performance.

In some embodiments, the analysis unit controls the embedding unit to switch the watermark signal on and off as described above. In other embodiments, the analysis unit may control which portion of the information signal a watermark is embedded in.

FIG. 3 shows a schematic block diagram of an embodiment of a system for embedding a watermark in an audio signal. The audio watermark embedder generally designated 300 receives a random watermark sequence w[k] and an input audio signal x[n], and embeds the watermark in the audio signal by modifying the envelope of the audio signal. The watermark sequence is a sequence of watermark symbols, e.g. a random sequence of symbols. In particular, the watermark symbols are embedded in respective frames of the input signal. This watermarking technique as such is described in Aweke N. Lemma et al., “A Temporal Domain Audio Watermarking Technique”, IEEE Trans. On Signal Processing, 2003, Vol. 51, No. 4, pp. 1088-1097, which is incorporated herein in its entirety by reference.

The watermark sequence w[k] and the input signal x[n] are fed in the transformation unit 301 that generates a modifier signal m[n]. In this embodiment, the transformation unit comprises a multi-rate circuit 311 that receives the watermark sequence w[k] and converts it into a slowly varying narrowband signal w[n]. For each symbol of w[k], the signal w[n] is given by w[n]=w[k]s[n], where s[n] is a window shaping function.

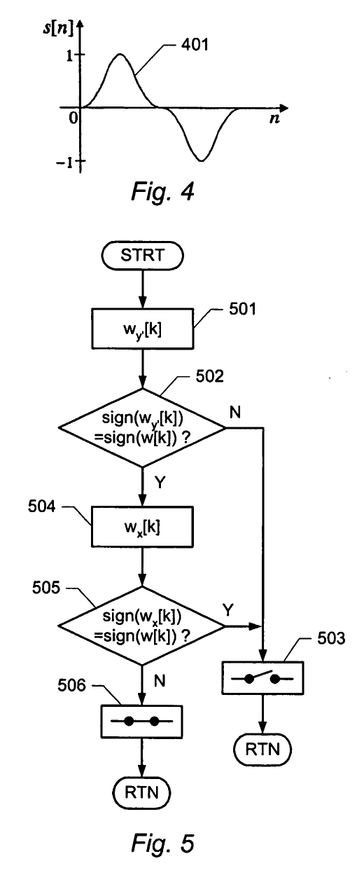

FIG. 4 schematically illustrates an example of a window shaping function for use in the watermark embedder of FIG. 3. The window shaping function 401 is a bi-phase window shaping function. However, other choices of s[n] are possible as well.

Again referring to FIG. 3, the transformation unit 301 further comprises a filter 313 for filtering the input signal x[n] and a multiplier 312. For example, the filter 313 may be a band-pass filter, a high-pass filter or the like. The multiplier 312 multiplies the filtered input signal 314 with the watermark signal w[n] generated by the multi-rate circuit 311 to obtain the modifier signal m[n]. Hence, m[n] is an envelope-modulated signal whose carrier is the filtered version of the input signal x[n].

The remaining components are similar to the corresponding blocks described in connection with FIG. 1. The modifier signal m[n] is scaled by a gain control unit 302 resulting in a scaled modifier signal m′[n]. The gain control unit 302 is controlled via a control signal 308 received from a psycho-acoustic model unit 309 controlling the embedding depth of the watermark. The scaled modifier signal m′[n] is fed to an adder circuit 307 via a switch 306. The adder circuit 307 further receives the input signal x[n] and generates a final watermarked signal y[n] as a combination of the input signal modified by the signal received from the switch 306. At the detection side (not explicitly shown) the watermark is subsequently detected by an envelope discrimination circuit.

The scaled modifier signal m′[n] is further fed into a second adder circuit 303 that further receives the input signal x[n] and that combines the input signal with the scaled modifier signal m′[n] resulting in the watermarked signal y′[n].

The watermarked signal y′[n] is fed into an analysis unit 304. The analysis unit 304 comprises an analysis block 341 that receives the signal y′[n] and the input signal x[n], and it determines watermark estimates for the signals y′[n] and x[n]. These estimates are fed into the control block 342 of the analysis unit that generates a control signal 305 for controlling the switch 306. In particular, the analysis unit 304 determines whether adding the modifier signal m′[n] to the input signal x[n] results in a detectable modification of the input signal, and whether the input signal x[n] inherently comprises properties that would have been induced by the watermark.

The operation of the analysis unit 304 will now be described in more detail with reference to FIG. 5. FIG. 5 shows a flow diagram of the steps performed by the analysis unit 304.

The watermarked signal generated by the adder 307 may be written as

y[n]=x[n](1+Gw[n]), (1)

where G is the embedding strength or gain factor introduced by the gain control unit 302. Here, for simplicity, it has been assumed that the filter function of the filter 313 is H=1.

For the purpose of the present description, yₖ[n] denotes the k-th frame of the output signal corresponding to the k-th watermark symbol w[k]. Consequently, yₖ[n] may be expressed as yₖ[n]=x[n](1+Gw[k]s[n]).

Furthermore, for the purpose of the present description, the watermark sequence w[k] is assumed to comprise symbols that are uniformly distributed in the interval [−1,1], and it is further assumed that G<<1.

In the watermark detector, the watermark is estimated by first extracting an estimate wₖ[k] of the input watermark symbol w[k] using the expression

$${w}_{k} [ k ] = \frac{{\sum }_{n = {kT}_{s}}^{( k + 1 / 2 ) {T}_{s} - 1} {\vert {y}_{k} [ n ] \vert}^{2} - {\sum }_{n = ( k + 1 / 2 ) {T}_{s}}^{( k + 1 ) {T}_{s} - 1} {\vert {y}_{k} [ n ] \vert}^{2}}{{\sum }_{n = {kT}_{s}}^{( k + 1 / 2 ) {T}_{s} - 1} {\vert {y}_{k} [ n ] \vert}^{2} + {\sum }_{n = ( k + 1 / 2 ) {T}_{s}}^{( k + 1 ) {T}_{s} - 1} {\vert {y}_{k} [ n ] \vert}^{2}} . \qquad ( 2 )$$

Here, Tₛ is the length of a frame measured in numbers of samples. In the above equation, without loss of generality, Tₛ has been assumed to be even. It is noted that the above expression further assumes that the window shaping function is a bi-phase function as illustrated in FIG. 4. For other types of window shape function other forms of estimates may be used.

Introducing the following abbreviations for the sums in equation (2)

$${E}_{yt} [ k ] = {\sum }_{n = {kT}_{s}}^{( k + 1 / 2 ) {T}_{s} - 1} {\vert {y}_{k} [ n ] \vert}^{2}$$

$${E}_{yu} [ k ] = {\sum }_{n = ( k + 1 / 2 ) {T}_{s}}^{( k + 1 ) {T}_{s} - 1} {\vert {y}_{k} [ n ] \vert}^{2} ,$$

the estimated watermark wₖ[k] may be written as

$${w}_{y} [ k ] = \frac{{E}_{yt} [ k ] - {E}_{yu} [ k ]}{{E}_{yt} [ k ] + {E}_{yu} [ k ]} . \qquad ( 3 )$$

For the purpose of the following description, it is assumed that the watermark sequence is a binary sequence of randomly selected symbols w[k] ε {−1,1}. Hence, in this case a watermark symbol is successfully detected, if the estimated watermark symbol wₖ[k] has the same sign as w[k].

Referring to FIG. 5, in initial step 501, the analysis unit determines the estimated watermark w_{y′}[k] in the k-th frame of the watermarked signal y′[n]. In the embodiment described above, the analysis unit may calculate w_{y′}[k] according to eqn. (3) applied to the signal y′, i.e. according to

$${w}_{{y}^{′}} [ k ] = \frac{{E}_{{y}^{′} t} [ k ] - {E}_{{y}^{′} u} [ k ]}{{E}_{{y}^{′} t} [ k ] + {E}_{{y}^{′} u} [ k ]} .$$

In step 502, the analysis unit determines whether the estimated watermark w_{y′}[k] corresponds to the actually embedded watermark w[k]. In an embodiment with binary watermark symbols, this test simply reduces to comparing the polarities of w_{y′}[k] and w[k]. If sign(w_{y′}[k])≠sign(w[k]), the analysis unit determines that the embedding did not result in a detectable change and generates a corresponding control signal causing the switch 306 to open (step 503). Consequently, no modification is applied to the signal portion corresponding to the k-th watermark symbol. In one embodiment, the above test may be repeated with a higher embedding strength and, if the embedding at maximum embedding strength does not result in a detectable modification, the switch 306 is opened.

If the analysis unit determines a detectable change, the process proceeds to step 504 where the estimated watermark wₓ[k] in the k-th frame of the input signal x[n] is determined. In the embodiment described above, the analysis unit may calculate wₓ[k] according to eqn. (3) applied to the signal x, i.e. according to

$${w}_{x} [ k ] = \frac{{E}_{xt} [ k ] - {E}_{xu} [ k ]}{{E}_{xt} [ k ] + {E}_{xu} [ k ]} .$$

In step 505, the analysis unit determines whether the watermark w[k] is already present in the input signal, i.e. prior to modification, i.e. whether the estimated watermark wₓ[k] corresponds to the w[k] symbol to be embedded. Again, in an embodiment with binary watermark symbols, this test simply reduces to comparing the polarities of wₓ[k] and w[k]. If sign(wₓ[k])=sign(w[k]), the analysis unit determines that the watermark symbol w[k] is inherently present in the input signal and generates a corresponding control signal causing the switch 306 to open, i.e. the process proceeds at step 503.

Otherwise, i.e. if none of the above criteria are fulfilled, the process proceeds at step 506, where the analysis unit generates a control signal causing the switch 306 to close.

In the embedder of FIG. 3, steps 502 and 504 are performed by the analysis block 341, while the remaining steps of the above analysis process are performed by the control block 342.

In summary, the analysis unit opens the switch 306, if either of the following conditions is satisfied:

sign(wₓ[k])=sign(w[k])

sign(w_{y}′[k])≠sign(w[k]) (4)

In the first instance, the switch is opened, because the original audio signal inherently includes a property that is desired by the detection. Consequently, there is no need to further modify the input signal. In the second instance, the switch is opened, because the modification does not result in correct detection of the watermark symbol. Consequently, the modification would affect the signal quality without serving a purpose.

As in the previous embodiment, it is understood that the switch 306 may be configured to cause a continuous, smooth transition from an open state to a close state and vice versa, thereby reducing possible artifacts in the watermarked signal y caused by abrupt transitions. In other embodiments, the switch 306 may be replaced by an automatic gain control unit continuously controlling the modification strength based on the degree to which the above mentioned two criteria are fulfilled.

In yet another variation of the present embodiment, a more robust result may be obtained by replacing the above conditions of eqn. (4) by the following conditions:

sign(wₓ[k]−ε·sign(w[k]))=sign(w[k])

sign(w_{y′}[k]−ε·sign(w[k]))≠sign(w[k])

Here ε is a small positive real number.

In the above a watermark embedding method and system are disclosed that provide a reduced modification of the information signal. In particular, for the same amount of information added, the disclosed system results in a better robustness. Conversely, for the same robustness the disclosed system causes less modification of the input signal, thereby providing a perceptually improved signal quality.

It is noted that the above arrangements may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It should be noted that the above-mentioned embodiments illustrate rather than limit the invention, and that those skilled in the art will be able to design many alternative embodiments without departing from the scope of the appended claims.

For example, the invention is not limited to audio files but may be used in connection with any other information signal, such as movies, pictures, multimedia data, or the like.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of embedding a watermark signal in an information signal to obtain a watermarked information signal; the method comprising
determining a predetermined first property of a first part of the information signal, said predetermined first property being indicative of whether at least a predetermined first part of the watermark signal is detectable in the first part of the information signal;
embedding the at least first part of the watermark in the first part of the information signal to obtain the watermarked information signal, if the at least first part of the watermark signal is determined not to be detectable in the first part of the information signal; otherwise generating the watermarked information signal to include the first part of the information signal.

2. A method according to claim 1, wherein embedding the at least first part of the watermark in the first part of the information signal to obtain the watermarked information signal comprises
embedding the at least first part of the watermark in the first part of the information signal to obtain a modified part-signal;
determining a predetermined second property of the modified part-signal, said second property being indicative of whether said embedding results in a detectable modification of the first part of the information signal; and
generating the watermarked information signal to include the modified part-signal, if the embedding is determined to result in a detectable modification of the first part of the information signal and if the at least first part of the watermark signal is determined not to be detectable in the first part of the information signal; otherwise generating the watermarked information signal to include the first part of the information signal.

3. A method according to claim 1; wherein determining a predetermined first property comprises determining a first estimated watermark symbol from a first signal frame of a sequence of signal frames of the information signal; and wherein embedding the at least first part of the watermark in the first part of the information signal to obtain the watermarked information signal comprises
determining whether the estimated first watermark symbol matches a predetermined first watermark symbol of a sequence of watermark symbols; and
embedding the first watermark symbol in the first signal frame to obtain a final watermarked signal frame, if the first estimated watermark symbol does not match the first watermark symbol; otherwise selecting the first frame as the final watermarked signal frame.

4. A method according to claim 3, wherein embedding the first watermark symbol in the first signal frame to obtain a final watermarked signal frame further comprises
embedding the first watermark symbol in the first signal frame to obtain a modified signal frame
determining a second estimated watermark symbol from the modified signal frame;
determining whether the estimated second watermark symbol matches the first watermark symbol; and
selecting the modified signal frame as the final watermarked signal frame, if the second estimated watermark symbol matches the first watermark symbol and if the first estimated watermark signal does not match the first watermark signal; otherwise selecting the first signal frame as the final watermarked signal frame.

5. A method according to claim 1, wherein the information signal is an audio signal and wherein the watermark signal is an audio watermark signal.

6. A method according to any claim 1, wherein the information signal is divided into a sequence of frames, and the first part of the information signal is a first one of said sequence of frames.

7. A method according to any claim 1, wherein the first part of the watermark comprises at least a first watermark symbol of a sequence of watermark symbols.

8. A method according to claim 7, wherein the sequence of watermark symbols comprises a sequence of binary watermark symbols.

9. An arrangement for embedding a watermark in an information signal; the arrangement comprising
analyzing means (104; 202; 304) for determining a predetermined first property of a first part of the information signal, said predetermined first property being indicative of whether at least a predetermined first part of the watermark signal to be embedded is detectable in the first part of the information signal;
embedding means (103,107; 201; 303,307) for embedding the at least first part of the watermark in the first part of the information signal to obtain a modified part-signal;
a watermarked signal generator (106,107; 201; 306,307) for generating a final watermarked information signal; and
control means (104; 202; 342) for controlling the watermarked signal generator to include the modified part signal in the final watermarked information signal, if the at least first part of the watermark signal is determined not to be detectable in the first part of the information signal; otherwise controlling the watermarked signal generator to include the first part of the information signal in the final watermarked information signal.

10. A watermarked information signal generated by a method according to claim 1, the watermarked information signal comprising a plurality of part-signals, a first subset of the plurality of part-signals having embedded therein respective watermark symbols, a second subset of part-signals having no watermark symbols embedded therein.

11. A method of embedding a watermark signal in an information signal to obtain a watermarked information signal; the method comprising
embedding at least a first part of the watermark in a first part of the information signal to obtain a modified part-signal;
determining a predetermined first property of the modified part-signal, said first property being indicative of whether said embedding results in a detectable modification of the first part of the information signal;
generating the watermarked information signal to include the modified part-signal, if the embedding is determined to result in a detectable modification of the first part of the information signal; otherwise generating the watermarked information signal to include the first part of the information signal.

12. An arrangement for embedding a watermark in an information signal; the arrangement comprising
embedding means (103; 201; 303) for embedding at least a first part of the watermark in a first part of the information signal to obtain a modified part-signal;
analyzing means (104; 202; 304) for determining a predetermined first property of the modified part-signal, said first property being indicative of whether said embedding results in a detectable modification of the first part of the information signal;
a watermarked signal generator (106,107; 201; 306,307) for generating a final watermarked information signal; and
control means (104; 202; 342) for controlling the watermarked signal generator to include the modified part-signal in the final watermarked information signal, if the embedding is determined to result in a detectable modification of the first part of the information signal; otherwise controlling the watermarked signal generator to include the first part of the information signal in the final watermarked information signal.
